(19) United States
(12) Patent Application Publication
(10) Pub. No.: US 2007/0296868 A1
(43) Pub. Date: Dec. 27, 2007

(54) METHOD AND APPARATUS FOR AUTOMATIC COMPENSATION OF SKEW IN VIDEO TRANSMITTED OVER MULTIPLE CONDUCTORS

(75) Inventor: Raymond William Hall, Riverside, CA (US)

Correspondence Address: THE HECKER LAW GROUP, 1925 CENTURY PARK EAST, SUITE 2300, LOS ANGELES, CA, 90067, US

(73) Assignee: RGB SYSTEMS, INC., (DBA EXTRON ELECTRONICS), Anaheim, CA (US)

(21) Appl. No.: 11/309,120

(22) Filed: Jun. 23, 2006

(51) Int. Cl. H04N 5/52

(52) U.S. Cl. 348/685

(57) ABSTRACT

A method and apparatus for automatic detection and compensation of skew between color components of a video source transmitted over a plurality of twisted pair conductors are presented. The system includes a receiver configured to receive separate components of a video source over each twisted pair conductor in a twisted pair cable. Each color component includes a reference signal. High speed comparators and samplers are used to detect the reference signal and measure the skew between the color components. Delay is applied to the first arriving color components to synchronize them in time with the last arriving color component. Skew measurement is continuous and adjustment is automatic while the receiver is receiving a video signal.

### FIELD OF THE INVENTION

This invention relates to the field of video transmission. More specifically the invention relates to compensation for skew delay in video signals transmitted over multiple conductors, including twisted pair conductors.

### BACKGROUND OF THE INVENTION

Cables are one method commonly used to convey electronic video signals from a source device (e.g., a video camera or a DVD player) to a destination device (e.g., a video display screen). Two types of cable commonly used for video transmission are coaxial cable and twisted pair cable. It is desirable for the video signal at the destination device to correspond accurately to the original video signal transmitted by the source device. “Insertion loss” is a term used to describe signal degradation that occurs when a video or other signal is transmitted over a transmission medium such as a cable. Insertion loss is typically caused by the physical characteristics of the transmission cable.

Typically, insertion loss is proportional to the cable length: longer length transmission cables will exhibit greater loss than shorter length cables. Coaxial cables typically exhibit less insertion loss than twisted pair cables. However, coaxial cables are more expensive and difficult to install than twisted pair cables. Twisted pair cables typically are manufactured as bundles of several twisted pairs. For example, a common form of twisted pair cable known as “Category 5” or “CAT5” cable comprises four separate twisted pairs encased in a single cable. CAT5 cable is typically terminated with an eight-pin RJ45 connector.

Video signals come in a variety of formats. Examples are Composite Video, S-Video, and YUV. Each format uses a color model for representing color information and a signal specification defining characteristics of the signals used to transmit the video information. For example, the “RGB” color model divides a color into red (R), green (G) and blue (B) components and transmits a separate signal for each color component.

In addition to color information, the video signal may also comprise horizontal and vertical sync information needed at the destination device to properly display the transmitted video signal. The horizontal and vertical sync signals may be carried over separate conductors from the video component signals. Alternatively, they may be added to one or more of the video signal components and transmitted along with those components.

For RGB video, several different formats exist for conveying horizontal and vertical sync information. These include RGBHV, RGBS, RGsB, and RsGsBs. In RGBHV, the horizontal and vertical sync signals are each carried on separate conductors. Thus, five conductors are used: one for each of the red component, the green component, the blue component, the horizontal sync signal, and the vertical sync signal. In RGBS, the horizontal and vertical sync signals are combined into a composite sync signal and sent on a single conductor. In RGsB, the composite sync signal is combined with the green component. This combination is possible because the sync signals comprise pulses that are sent during a blanking interval, when no video signals are present. In RsGsBs, the composite sync signal is combined with each of the red, green and blue components. Prior art devices exist for converting from one format of RGB to another. To reduce cabling requirements, for transmission of RGB video over anything other than short distances, a format in which the sync signals are combined with one or more of the color component signals are commonly used.

Thus, an RGB signal typically requires at least three separate cables for transmission of each of the red, green, and blue components and the combined horizontal and vertical sync information. If coaxial cable is used, three separate cables are required. If twisted pair conductors are used, three twisted pairs are also required, but a single CAT5 cable (which comprises four twisted pairs) can be used. Three of the four pairs may be used for the red, green, and blue components, respectively. The fourth pair is available for transmission of other signals (e.g., digital data, composite sync, and/or power). FIGS. 2 and 3 illustrate examples of how video signals may be allocated to the four pairs of twisted conductors in a CAT5 or similar cable.

In a CAT5 or similar cable, each end of each conductor is typically connected to one of eight pins of a standard male RJ-45 connector. In FIGS. 2 and 3, the first conductor pair corresponds to Pins 1 and 2; the second conductor pair corresponds to Pins 4 and 5; the third conductor pair corresponds to Pins 7 and 8; and the fourth conductor pair corresponds to Pins 3 and 6. For video signal configurations in which three or fewer conductor pairs are used for the transmission of the video signal, the remaining conductor pair or pairs (for example, the pair corresponding to Pins 3 and 6), may be used for communication of other signals, and/or for power transfer. Power transfer may be desirable if one of the devices is located remote from an external power source. For example, a source device may comprise a video surveillance camera located at a distance from an external power source, such as a power outlet, while the destination device comprises a video display unit located in a room with readily available house current. In such a configuration, the power needed to operate the video source device may be conveyed from the destination device to the source device via the twisted conductor pair not allocated for transmission of video signals.

FIG. 2 shows example pin configurations for a number of video signal formats. For example, with RGBHV video, as shown in the column headed “RGBHV” of FIG. 2, the twisted pair corresponding to Pins 1 and 2 carries the differential Red signals (i.e. Red+ and Red−) and the differential vertical sync signal (i.e. V Sync+ and V Sync−), the pair corresponding to Pins 4 and 5 carries the differential green signals (i.e. Green+ and Green−), and the pair corresponding to Pins 7 and 8 carries the differential Blue signals (i.e. Blue+and Blue-) and the differential horizontal sync signal (i.e. H Sync+ and H Sync−). In FIG. 2, the conductor pair corresponding to pins 3 and 6 is allocated to carrying a digital signal and power.

For RGBS (i.e. RGB with one composite sync signal), in the example of FIG. 2, as shown in the column headed “RGBS,” the same pin assignments are used for the red, green and blue components as for RGBHV, with the composite sync signal combined with the Blue signal (i.e. Blue/C Sync+ and Blue/C Sync−). The composite sync signal could alternatively be combined with the Red component signal, or the Green component signal (as is done in the RGsB format, as shown in the column headed “RGsB” in FIG. 2). When the format to be transmitted is RsGsBs (i.e. composite sync signal added to each color component), as shown in the column headed “RsGsBs” in FIG. 2, the same pin assignments are used for each of the red, green and blue components as for RGBHV, except in this case the composite sync signal is added to each of the three color components.

In addition to showing example pin assignments for RGB signals, FIG. 2 also shows example pin assignments for component video, S-Video, and composite video. FIG. 3 shows an example of pin assignments that allow Composite video and S Video signals to share the same four-twisted pair cable.

Whenever multiple cables are used to transmit different components of a video signal, they must be properly combined at the destination to reproduce the transmitted video signal. For example, the components must be synchronized at the receiving station to prevent distortion in the video reproduction. Differences in arrival time of the various signal components may become an issue if the transmission distance is long and there are differences in length among the multiple conductors. Such differences in arrival time are referred to as “skew.” CAT5 or similar twisted pair cables are particularly prone to skew, because, according to the CAT5 specification, the twist rate of each cable pair is different (to reduce cross-talk between the adjacent cables). Over long distances, this difference in twist rate can result in significant differences in conductor path length of the different pairs.

Prior art skew compensation devices exist that allow delays to be manually added to one or more of the video signal components to reduce the skew among the different cables. An example of such a prior art skew compensation device is the SEQ 100 BNC skew delay equalizer sold by Extron Electronics. The prior art skew compensation devices are typically placed between the receiving end of the video transmission cables and the input to the destination device. They require manual selection of the amount of delay to be applied to each signal component.

### SUMMARY OF THE INVENTION

The invention comprises a method and apparatus for automatic compensation for skew among multiple signal components transmitted over multiple pairs of conductors. The present invention is particularly applicable to the transmission of video over long lengths of twisted pair conductors. Embodiments of the invention may be implemented as a separate device and/or as part of a video transmission system that provides other types of signal compensation and equalization as well.

In one or more embodiments, a reference signal having a known form is provided to each pair of conductors carrying a component of a video signal from a transmitter to a receiver. The reference signal may, for instance, comprise a modified form of a sync signal of the input video signal (e.g. the horizontal sync signal). The reference signal in each pair of conductors is detected by high speed comparators at the receiver. High speed samplers are used to actively measure the amount of skew between the reference signals in the conductor pairs. Based on those measurements, corresponding delays are applied to the fastest-arriving signal components to synchronize their arrival with the slowest arriving component. In one or more embodiments, skew measurements are taken alternately at coarse and fine resolutions, and corresponding coarse and fine delays are applied according to the respective skew measurements.

Further objects, features, and advantages of the present invention over the prior art will become apparent from the detailed description of the drawings which follows, when considered with the attached figures.

### BRIEF DESCRIPTION OF THE DRAWINGS

FIG. 1 is an illustration of long distance twisted pair transmission apparatus in accordance with an embodiment of the present invention.

FIG. 2 is an illustration of allocation of the conductors of a twisted pair cable for various video formats in accordance with an embodiment of the present invention.

FIG. 3 is an illustration of allocation of the conductors of a twisted pair cable for video signals in accordance with an embodiment of the present invention.

FIG. 4 is a block diagram illustration of architecture of a transmitter in accordance with an embodiment of the present invention.

FIG. 5 is an illustration of a polarity converter in accordance with an embodiment of the present invention.

FIG. 6 is a block diagram illustration of architecture of a receiver in accordance with an embodiment of the present invention.

FIG. 7 is an illustration of a sync stripper circuit in accordance with an embodiment of the present invention.

FIG. 8 is an illustration of amplifier configuration for variable length twisted pair cables in accordance with an embodiment of the present invention.

FIG. 9 is an illustration of the skew compensation circuit in accordance with an embodiment of the present invention.

FIG. 10 is an illustration of an adjustable delay circuit as used in one or more embodiments of the present invention.

FIG. 11 is an illustration of a skew detection circuit in accordance with an embodiment of the present invention.

### DETAILED DESCRIPTION OF THE INVENTION

The invention comprises a method and apparatus for compensating for skew in video signals transmitted over a plurality of conductor pairs. In the following description, numerous specific details are set forth to provide a more thorough description of the present invention. It will be apparent, however, to one skilled in the art, that the present invention may be practiced without these specific details. In other instances, well-known features have not been described in detail so as not to obscure the invention.

In one or more embodiments, a transmitter is configured to transmit video signals over multiple conductor pairs to a receiver. Each conductor pair carries a component of the video signal. The transmitter obtains input video signals from a video source device (e.g. a video camera or a DVD player). In one or more embodiments, the transmitter modifies the input video signal by adding a reference signal having a predetermined form to each component of the input video signal. The transmitter transmits the modified input video signal over the multiple conductor pairs to the receiver. The receiver processes the modified input video signal and provides a reprocessed video signal to a destination device (e.g. a video recorder or video display). In one or more embodiments, the reference signal comprises a horizontal sync signal of the input video signal.

Processing of each component of the modified video signal at the receiver is done based on the reference signal. In one embodiment, when the receiver is coupled to the transmitter via the conductor pairs, the receiver recognizes that a signal is present at its input terminals and begins processing of the input signal. The receiver attempts to detect the reference signal in each signal component. In one or more embodiments, the receiver comprises a closed loop signal amplifier for each signal component. The receiver initially sets the loop gains of the amplifiers to maximum for purposes of detecting the reference signal. In one or more embodiments, once the reference signal is detected in a particular signal component, the receiver adjusts the DC and/or AC signal amplitude and peaking for that signal component until the reference signal is restored to its original form.

Once the reference signal for each signal component has been restored, skew between the different video signal components is measured. Delay is added to the earliest arriving signal component(s) such that they arrive at the same time as the slowest arriving signal component. In one or more embodiments, sequential coarse and fine skew adjustments are made.

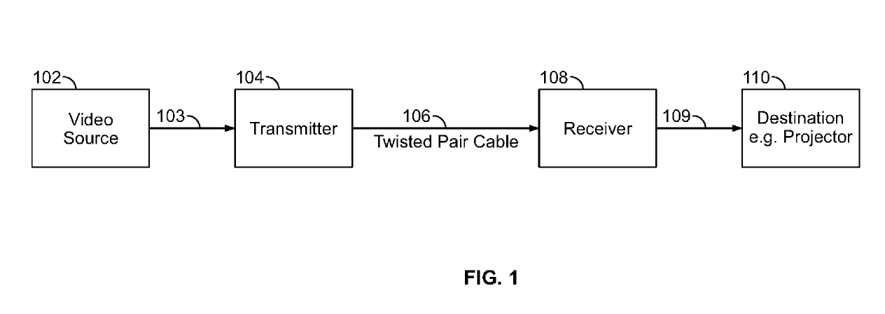

An embodiment of a video transmission system comprising the present invention is illustrated in FIG. 1. The video transmission system of FIG. 1 comprises video source 102, cable 103, transmitter 104; twisted pair cable 106; receiver 108, cable 109 and destination device 110. Cable 103 couples the video (and audio, if applicable) signals from source 102 to transmitter 104. Cable 103 may comprise any suitable conductors known in the art for coupling the type of video signal generated by video source 102 to transmitter 104. Transmitter 104 comprises multiple input terminals for accepting different input signal formats. For example, transmitter 104 may comprise connectors for accepting a composite video signal, an S-Video signal, a digital video signal, an RGB component video signal, etc. Transmitter 104 may also comprise standard audio connectors such as, for example RCA input jacks.

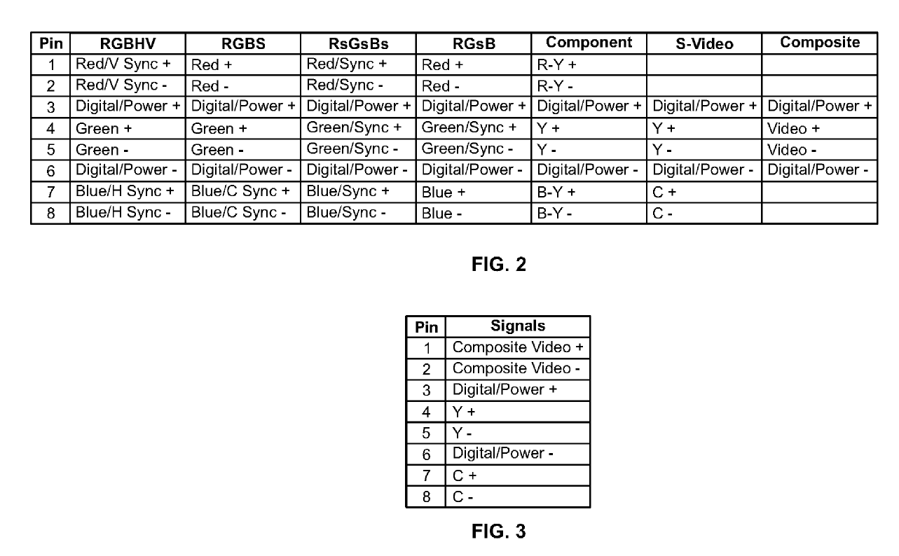

In one or more embodiments, cable 106 comprises a cable bundle of multiple twisted pair conductors. For example, cable 106 may comprise a CAT5 or similar cable comprising four pairs of twisted conductors and terminated with standard male RJ-45 connectors that mate with matching female RJ-45 connectors on the transmitter and receiver. The pairs of twisted conductors may, for example, be allocated as shown in FIGS. 2 and 3.

Example embodiments of the present invention are described using RGBHV as an example video input signal format. However, it will be clear to those of skill in the art that the invention is not limited to RGBHV and that other video formats may be used in which the video signal is transmitted over more than one conductor pair.

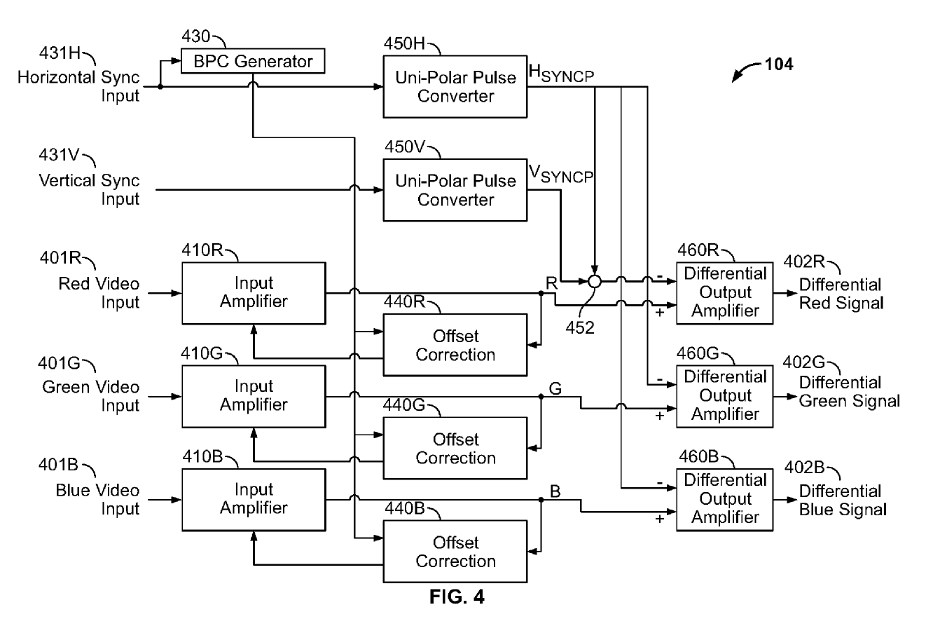

FIG. 4 is a block diagram showing the architecture of transmitter 104 of FIG. 1 in an embodiment of the present invention. In the embodiment shown in FIG. 4, transmitter 104 receives a video source signal comprising separate video input signals and sync input signals. For example, if the video input source signal is in RGBHV format, video input signals comprise the R, G and B signals, while the sync input signals comprise the H and V sync signals. In other embodiments, the sync signals may be combined with one or more of the video component signals.

In embodiments configured for S-Video; Component video; or RGB video with a combined synchronization signal, the synchronization signals may be detected and extracted from the video information and then re-combined, after conditioning, with the video to provide the appropriate reference signals for skew measurements. In such embodiments, the synchronization signals are stripped from the incoming video signals, conditioned, and then recombined with the appropriate video data, in the transmitter. Thus, configured, the input signal at the receiver provides the necessary information for the receiver to detect and compensate for skew, and also re-generate the appropriate synchronization signals for these video formats.

In the RGBHV embodiment of FIG. 4, transmitter 104 comprises horizontal and vertical sync input terminals 43 1H and 43 IV, red, green and blue video input terminals 401R, 401G and 401B, input amplifiers 410R, 410G, and 410B, back porch clamp (BPC) generator 430, offset correction circuits 440R, 440G, and 440B, uni-polar pulse converters 450H and 450V, differential output amplifiers 460R, 460G and 460B, and differential output terminals 402R, 402G and 402B. Transmitter 104 may also contain local output amplifiers for each input signal (not shown) that provide a local video monitor output signal.

Input amplifiers 410 receive the input video signal from video input terminals 401, and uni-polar pulse converters 450 receive the sync input signals from sync input terminals 431. In one or more embodiments, separate amplifiers are utilized for each video component signal. For example, in an embodiment for an RGBHV input signal, three input amplifiers 410 for the video components (one each for the R, G, and B components) and two uni-polar pulse converters 450 for the sync signals (one each for the H and V sync signals) are used.

Input amplifiers 410 are used in conjunction with horizontal sync BPC generator 430 and offset correction circuits 440 to detect and compensate for any DC offset in the source video signal. In the embodiment of FIG. 4, offset correction circuits 440 determine the DC offset for each video component using the back porch clamp signal from the BPC generator 430, and the amplified video source signal from input amplifiers 410. Offset correction circuits 440 apply compensation to each video component via a feedback loop comprising the respective input amplifier 410 for that component.

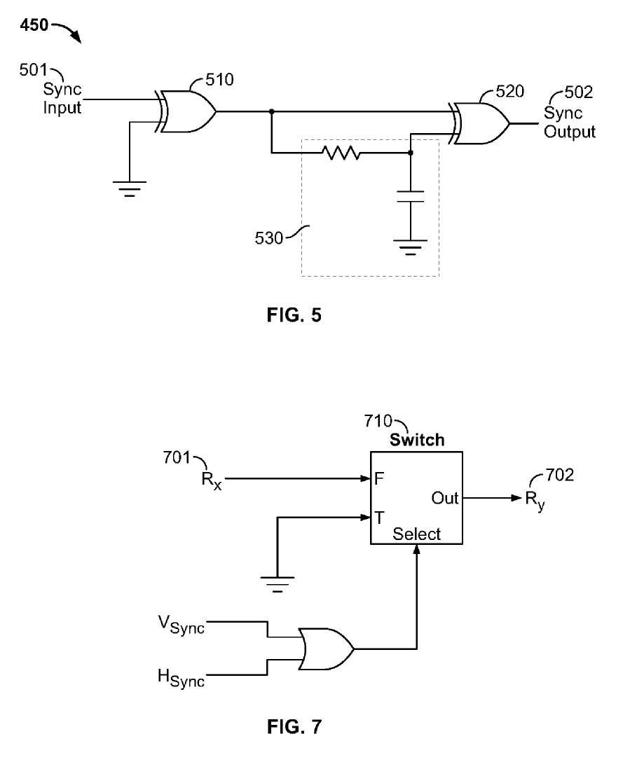

The vertical and horizontal synchronization signals 431H and 431V are coupled to uni-polar pulse converters 450. Uni-polar pulse converters 450 assure that sync signals output by transmitter 104 are always the same polarity regardless of the polarity of the input. An embodiment of a uni-polar pulse converter 450 is illustrated in FIG. 5.

In the embodiment of FIG. 5, pulse converter 450 comprises two exclusive-OR gates (e.g. 510 and 520) that process the received sync input signal. Initially, the sync input signal 501 (e.g. 431H and 431V) is exclusive-ORed with ground in gate 510 and then the output of gate 510 is filtered in low-pass filter 530 (which in one or more embodiments comprises a resistor and capacitor circuit) and exclusive-ORed with itself (i.e. unfiltered output of gate 510) in gate 520 to generate the polarity-corrected sync output signal 502.

In one or more embodiments, the horizontal sync signal H_{SYNCP} is used as both the horizontal sync signal and as the reference pulse signal, which is used in the receiver for skew correction. H_{SYNCP} is therefore added to each of the video signal component signals. In addition, in one or more embodiments, the vertical sync signal V_{SYNCP} is added to one or more of the video components to provide vertical sync information to the receiver.

In the embodiment of FIG. 4, only the red video component signal is used to convey the vertical sync information. Thus, both the vertical and horizontal sync signals are added to the red video component signal, while only the horizontal sync signal is added to the blue and green component signals. H_{SYNCP} is summed with V_{SYNCP} at node 452 and subtracted from the red video component signal (added to the negative input terminal) at differential amplifier 460R. H_{SYNCP} is subtracted from the green video component at differential amplifier 460G; and H_{SYNCP} is subtracted from the blue video component at differential amplifier 460B. In this way, a negative reference pulse (i.e. H_{SYNCP}) is simultaneously added to all three differential video output signals.

Differential output amplifiers 460 receive the reference, sync (if applicable) and video signals and provide corresponding amplified differential driver signals to differential output terminals 402. In one or more embodiments, differential output terminals 402 comprise a female RJ-45 connector using pin assignments such as those shown in FIG. 2 (pins 3 and 6 may be used for transmission of power, digital signals, and/or audio signals). Differential output terminals 402 may be connected via twisted pair cable 106 of FIG. 1 to receiver 108.

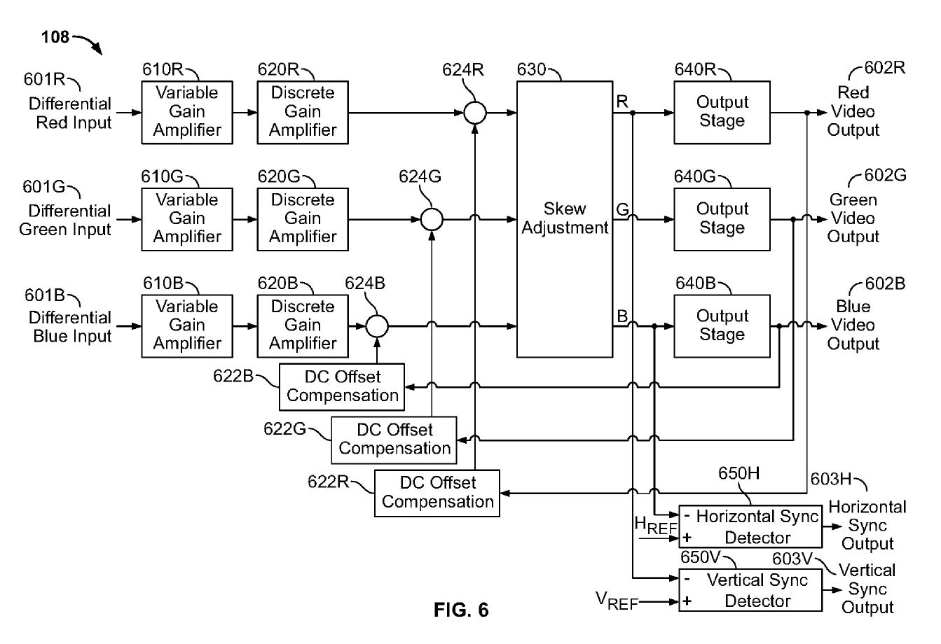

Receiver 108 receives the differential video signals from transmitter 104 via twisted pair cable 106. Receiver 108 processes the differential video signals to compensate for skew and signal degradation and then outputs the compensated video signals to a destination device such as projector 110. FIG. 6 is a block diagram of receiver 108 in accordance with an embodiment of the present invention.

In the embodiment of FIG. 6, Receiver 108 comprises variable gain amplifiers 610R, 610G and 610B, discrete gain amplifiers 620R, 620G and 620B, skew adjustment circuit 630; output stages 640R, 640G and 640B, DC offset compensation circuits 622R, 622B and 622G, and sync detectors 650H and 650V. Receiver 108 may also include differential output terminals (not shown) that output a buffered and/or amplified version of the input signals for daisy chaining to other receivers.

The differential video input signals 601 (e.g. 601R, 601G and 601B) are coupled to the respective variable gain amplifiers 610 and discrete gain amplifiers 620. Each variable gain amplifier 610 works together with the corresponding discrete gain amplifier 620 to compensate a respective one of the differential input video signals for insertion losses resulting from communication of the signal from transmitter 104 to receiver 108 over twisted pair cable 106. In one or more embodiments, each variable gain amplifier 610 is capable of providing a controllable, variable amount of gain over a range from zero (0) to a maximum value (K), and each discrete gain amplifier 620 provides amplification in controllable, discrete multiples of K (e.g. 0K, 1K, 2K, etc). Together, variable gain amplifiers 610 and discrete gain amplifiers 620 provide controllable amounts of variable gain over an amplification range equal to the sum of the maximum gain of variable gain amplifiers 610 and the maximum gain of discrete gain amplifiers 620. In one or more embodiments, K represents the amount of gain typically required to compensate for signal losses over a known length of cable (e.g. 300 feet).

In one or more embodiments, the total amount of gain provided by variable gain amplifiers 610 and discrete gain amplifiers 620 may be selected based on the length of cable 106, or may be automatically controlled, as described in co-pending U.S. patent application Ser. No. ______, entitled “Method And Apparatus For Automatic Compensation Of Video Transmitted Over Conductors”, specification of which is herein included by reference. The amount of gain provided by variable gain amplifiers 610 and discrete gain amplifiers 620 may be controlled, for example, using a micro-controller that determines the appropriate amount of gain to be applied based on actual and expected signal strength of the reference signal included in the video signals received from transmitter 104.

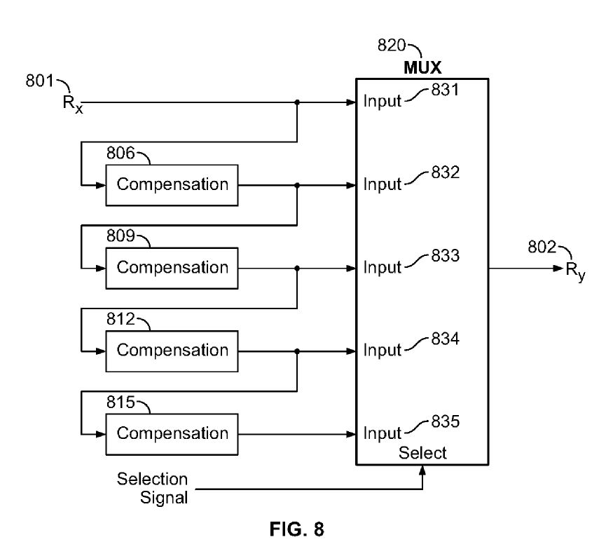

FIG. 8 shows a block diagram for a discrete gain amplifier 620 in one embodiment of the invention. In the embodiment of FIG. 8, discrete gain amplifier 620 comprises a multiplexer 820 and a plurality of compensation circuits 806, 809, 812 and 815. Each compensation circuit provides a fixed amount of gain that is approximately equal to the maximum amount of gain provided by a variable gain amplifier 610 (which may be selected, for example, to approximate the amount of gain needed to compensate for losses that occur for a nominal cable length, such as 300 feet). The compensation circuits are daisy changed, and the output of each successive compensation circuit is connected to one of the inputs of multiplexer 820.

In the embodiment of FIG. 8, input 831 of multiplexer 820 is connected to the unamplified input signal 801 (which may, for example, comprise one of the input video components 601 after it passes through a respective variable gain amplifier 610). Input 832 is connected to the output of compensation circuit 806, i.e. input signal 801 after it has been amplified by compensation circuit 806. Input 833 is connected to the output of compensation circuit 809 (i.e. input signal 801 after having been amplified by compensation circuits 806 and 809). Input 834 is connected to the output of compensation circuit 812 (i.e. input signal 801 after having been amplified by compensation circuits 806, 809 and 812). Input 835 is connected to the output of compensation circuit 815 (i.e. input signal 801 after having been amplified by compensation circuits 806, 809, 812 and 815). If K is the amount of gain provided by each compensation circuit, then the gain applied to input signal 801 will be 0K, 1K, 2K, 3K or 4K, depending on which of inputs 831, 832, 833, 834 or 835 is selected.

In the embodiment of FIG. 6, the gain-compensated input signals 601 are further compensated for DC offset and skew by DC offset compensation circuits 622 and skew adjustment circuit 630, respectively.

Skew compensation involves determining the skew between each separately transmitted color component signal and providing a compensating delay to the earliest arriving signals so that all color components are synchronized in time for output to the destination device. In one or more embodiments of the invention, skew compensation is accomplished using the reference signals added by transmitter 104 to each of the color component signals, as described with respect to FIG. 4.

For example, if the CAT5 cable is used to transmit the video signals from transmitter 104 to receiver 108, there will be differences in conductor length for each of the respective R, G and B video signal components because of the different twist rates for each twisted pair of a CAT5 cable. The signals transmitted on any pair that has a longer conductor length than the shortest conductor pair will take longer to arrive at receiver 108 because of the additional length. This time delay may be sufficient enough to distort the video at the destination.

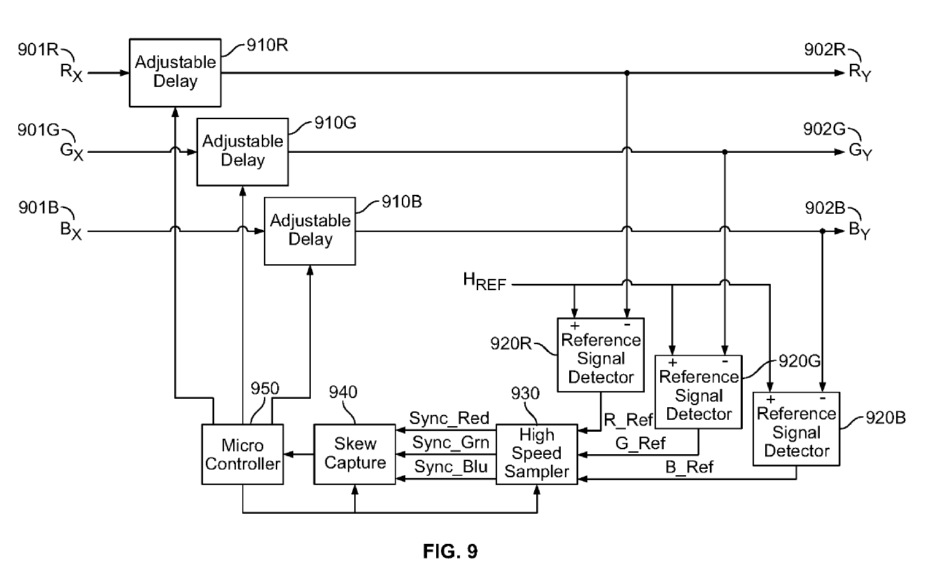

An illustration of the automatic skew adjustment circuit in one embodiment of the present invention is shown in FIG. 9. In the embodiment of FIG. 9, skew compensation is accomplished by measuring the skew (i.e. difference in arrival time) between the color component signals using: the circuit comprising reference signal detectors 920, high speed sampler 930, skew capture circuit 940, and micro-controller 950; and then applying compensating delays to the fastest arriving signals with adjustable delay circuits 910. In FIG. 9, subscripts “X” and “Y” for each of the R, G, and B video signals are used to refer to the input signal to the skew adjustment circuit and the output signals from the skew adjustment circuit, respectively.

In the embodiment of FIG. 9, the reference signal added by transmitter 104 to each transmitted video component is detected at the output of adjustable delays 910 by reference signal detector 920. In one or more embodiments, each reference signal detector 920 comprises a comparator which compares the respective video signal to a negative reference voltage threshold, generating a pulse when the reference signal is detected in the video signal. For example, signal detector 920R generates an output reference pulse signal R_ref corresponding to detection of the reference signal in the red component signal R_{Y}. Similarly, signal detector 920G generates an output reference pulse signal G_ref corresponding to detection of the reference signal in the green component signal G_{Y}, and signal detector 920B generates an output reference pulse signal B_ref corresponding to detection of the reference signal in the blue component signal B_{Y}.

The three reference pulse signals generated by reference signal detectors 920 feed into high speed sampler 930 which takes coarse and fine measurements of the reference pulse signals. The digital outputs of high speed sampler 930 (i.e. Sync_Red, Sync_Grn, and Sync_Blu) feed to skew capture circuit 940, wherein the skew is determined and subsequently fed to micro-controller 950. Micro-controller 950 determines the appropriate delay to be applied to each component signal to compensate for the measured skew, and commands adjustable delay circuits 910 to apply the appropriate delay to the two earliest arriving color component signals such that they will line up in time with the slowest arriving component signal.

In one or more embodiments, high speed sampler 930 comprises a SerDes (Serializer/Deserializer) receiver, which is commercially available. Generally, a SerDes receiver requires low voltage differential signals as input. Thus, the reference pulse signals generated by reference signal detectors 920 are converted to low voltage differential signals before being provided to the input terminals of the SerDes receiver.

In one or more embodiments, the SerDes receiver configuration of high speed sampler 930 samples each of the reference pulse signals at a given clock rate and stores the resultant state information in n-bit (e.g. seven bits) wide serial shift registers. That is, the SerDes receiver obtains an n-bit wide sample for each of the reference pulse signals at the given clock rate, which is set by an input clock signal. Each group of serial shift registers contains a time slice (i.e. snap shot) of the reference pulse signals' state. The SerDes receiver has a built-in phase lock loop, which multiplies the input clock signal by the number of bits (e.g. n-bits) so that one input clock cycle results in an internal clock that is n-times as fast as the input clock signal.

The SerDes receiver circuit may be configured for multiple or variable clock rates. A variable internal clock rate may be desirable to improve resolution. For example, if the n-bit (e.g. seven) register in a SerDes receiver is inadequate to provide the needed sample resolution for skew adjustment, it may be necessary to take samples at different clock rates (i.e. different resolutions) in order to measure skew to the desired precision.

In one or more embodiments, the sampling of the SerDes receiver is controlled by two incoming clock rates that are selectable by micro-controller 950. Each sample generates a resolution equal to n-bits multiplied by the clock interval (i.e. inverse of the clock rate). For example, a clock rate of 22 MHz generates a coarse sample with a resolution of 6.49 nanoseconds, and a clock rate of 66 MHz generates fine samples with a resolution of 2.16 nanoseconds. Using these two clock rates, the skew between color components signals can be measured, and adjusted, to within approximately two nanoseconds.

In the embodiment of FIG. 9, the captured samples for each of the three reference pulse signals in the seven registers of the SerDes receiver are loaded into parallel registers in skew capture circuit 940 during the SerDes receiver's output cycles for the coarse sample rate (e.g. 22 MHz) and for the fine sample rate (e.g. 66 MHz) for further processing.

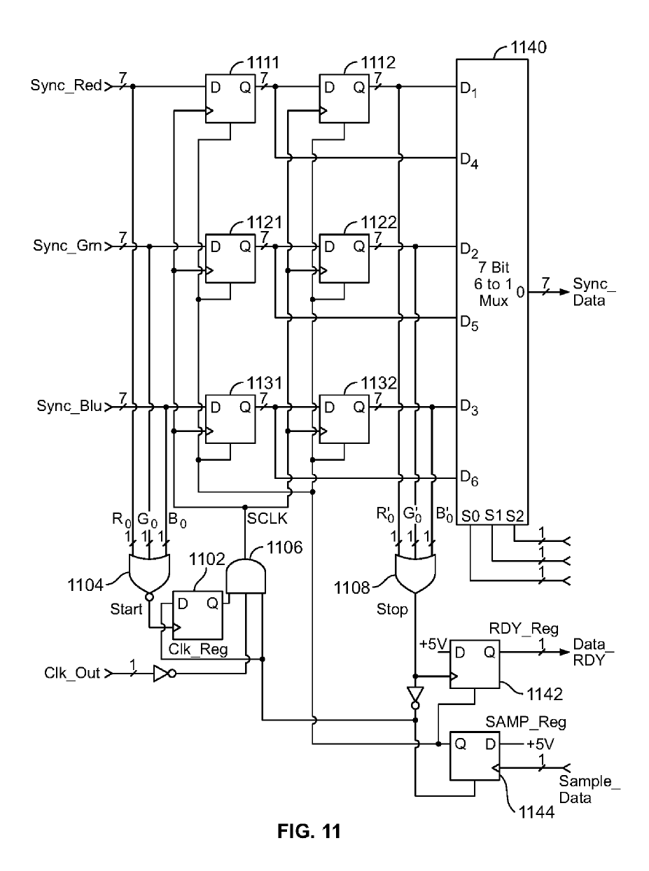

In one or more embodiments, skew capture circuit 940 may comprise the programmable logic shown in FIG. 11. In FIG. 11, the n-bit wide (e.g. 7-bits) captured samples for the “R” color component is represented as Sync_Red, the n-bit wide (e.g. 7-bits) captured samples for the “G” color component is represented as Sync_Grn, and the n-bit wide (e.g. 7-bits) captured samples for the “B” color component is represented as Sync_Blu.

In the embodiment of FIG. 11, skew capture circuit 940 comprises two data registers for holding the samples of the reference pulse signals for each of the color components. For example, in FIG. 11, skew capture circuit 940 comprises n-bit wide data register group 1111 and 1112 for the Sync_Red samples, n-bit wide data register group 1121 and 1122 for the Sync_Gm samples, and n-bit wide data register group 1131 and 1132 for the Sync_Blu samples. A larger time sample would be achieved using more data registers. The illustrated embodiment shows two sets of data registers for each color component.

Thus, skew capture circuit 940 of FIG. 11 is configured to store two successive n-bit samples for each of the three reference pulse signals. In one or more embodiments, data storage commences after micro-controller 950 requests a sample of the reference pulse signal data, for example, through assertion of a Sample_Data signal (i.e. “1”). As illustrated in FIG. 11, the Sample_Data signal, at the Q output of sample register (SAMP_Reg) 1144, resets the circuit registers, e.g., 1111, 1112, 1121, 1122, 1131, 1132, and 1142 in preparation for receipt of new skew data. When Sample_Data is asserted, the Q output of sample register 1144 goes high forcing a reset of registers 1111, 1112, 1121, 1122, 1131, 1132,andll42.

With the Q output of SAMP_Reg 1144 high and the data registers reset (i.e. R′₀, G′₀ and B′₀ at low), the output of OR gate 1108 (i.e. “Stop”) will be low. The inverter from the output of OR gate 1108 will present a high at the D input of the Clk_Reg 1102 and also one of the inputs of the AND gate 1106. At the end of the next set of reference pulses, Sync_Red, Sync_Gm, and Sync_Blu (R₀, G₀, and B₀) will all go low. Subsequently, the output of NOR gate 1104 (i.e. “Start”) goes high. This will clock the Clk_Reg 1102 causing its Q output to go high, enabling the start of clocking of the data registers. The “Start” signal goes high only after a set of reference pulses has occurred, this guarantees that sampling does not start in the middle of a set of reference pulses, but will capture data from the next full set of reference pulses.

In the embodiment of FIG. 11, data is clocked into the data capture registers, n parallel bits at a time, for each of the Sync_Red, Sync_Gm, and Sync_Blu signals. The data capture registers are double buffered such that two by n (i.e. 2×n) bits of time sequence data is stored for each of the three sync pulses. Data registers 1111 and 1112 capture the Sync_Red timing data, Data registers 1121 and 1122 capture the Sync_Grn timing data and Data registers 1131 and 1132 capture the Sync_Blu timing data.

Sync data is continuously sampled, representing consecutive input clocks from the SerDes Receiver. Data capture stops when the first rising edge of a sync pulse is detected at the output of one or more of the data registers 1112, 1122, and 1132. The “Stop” signal goes high when one or more of the R′₀, G′₀, or B′₀ signals goes high on the input of OR gate 1108. When the “Stop” signal goes high at least one of the sync reference pulses has gone high somewhere in the first n bits of the two by n (i.e. 2×n) bit data capture. The data registers hold a time related snap-shot (two n-bit samples) of each sync (i.e. reference) signals activity. Subsequently, assertion of the “Stop” signal disables gate 1106 thereby turning off the clock signals to the data registers 1111, 1112, 1121, 1122, 1131, and 1132. In addition, the rising edge of the “Stop” signal enables assertion of a Data_RDY signal (i.e. the Q output of RDY_Reg 1142) informing the micro-controller 950 that a time sample is ready to be read. Also the “Stop” signal releases the SAMP_Reg 1144 in preparation for the next sample request from the micro-controller.

When micro-controller 950 detects that data is captured, via the Data_RDY signal, each of the six n-bit wide registers is read at the output of MUX 1140 (i.e. “Sync_Data” in FIG. 11). The data is subsequently analyzed by micro-controller 950 to determine the amount of skew between the three signals. In one or more embodiments, an algorithm is used that discards bad samples and uses the average of a number of good samples (e.g. ten good samples) to calculate the observed skew. Corresponding skew adjustment (i.e. delay) is applied to those signals that arrive the earliest such that they synchronize in time with the latest arriving signal. The adjustments may be made in stages, for example, a coarse adjustment may first be applied followed by one or more finer adjustments.

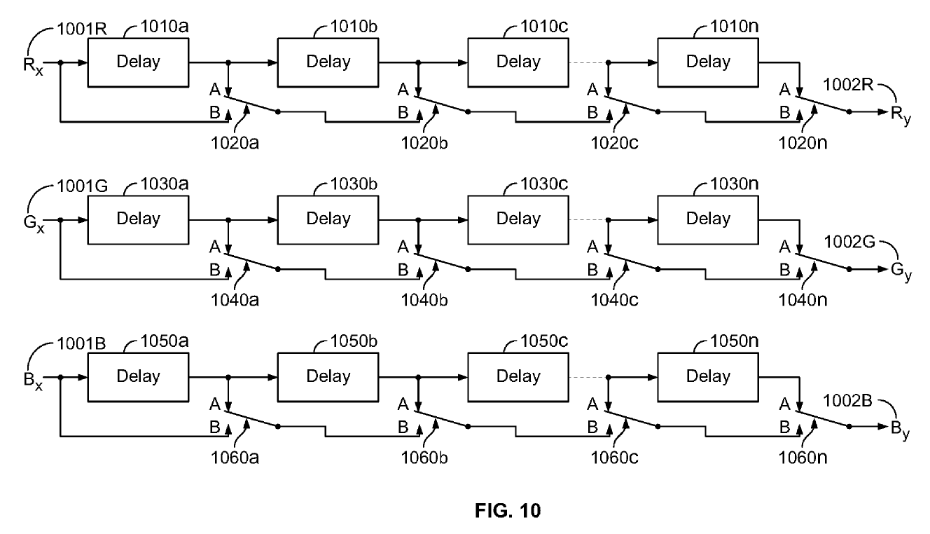

FIG. 10 is an illustration of an adjustable delay circuit as used in one or more embodiments of the present invention. As shown in FIG. 10, adjustable delay circuit 910 comprises a plurality delay blocks and switches arranged such that one or more delay blocks may be connected in series to provide the desired amount of delay for each of the respective color components. The delay blocks may utilize any of a number of delay circuitry configurations as known to those of skill in the art.

In the embodiment of FIG. 10, the adjustable delay circuits for each color component have an identical configuration. In the embodiment of FIG. 10, the adjustable delay circuit for the red input color component, R_{X} 1001R, comprises delay circuits 1010a, 1101b, 1010c and through 1010n ; and switches 1020a, 1020b, and 1020c through 1020n. The adjustable delay circuit for the green input color component, G_{X} 1001G, comprises delay circuits 1030a, 1030b, and 1030c thru 1030n; and switches 1040a, 1040b, and 1040c thru 1040n. The adjustable delay circuit for blue input color component, B_{X} 1001B, comprises delay circuits 1050a, 1050b, and 1050c thru 1050n; and switches 1060a, 1060b, and 1060c thru 1060n. The delay circuit components (e.g. 1010, 1030, and 1050) are preferably identical in structure and provide identical amount of delay. The minimum delay available from each delay circuit component is preferably equivalent to the resolution of high speed sampler, e.g., two nanoseconds. The delay structure may be any type of filter that provides delay with preferably a minimum amount of signal attenuation. For example, in one or more embodiments, an all pass filter (e.g., a non-minimum phase all-pass filter) is used.

The operation of the adjustable delay circuit for the red component signal is described in detail below. It will be understood, however, that the description applies to the adjustable delay circuits for the green and blue input component signals as well.

In the embodiment of FIG. 10, for the red component signal, switches 1020a through 1020n are all in the “B” position if no delay is to be introduced (e.g. if R_{X} 1001R is already the last arriving signal). If a single unit delay (e.g. two nanoseconds) is desired, then switch 1020a is placed in position “A”. The rest of the switches remain in position “B”. Thus delay component 1010a is inserted into the signal path, causing a single unit delay. Similarly, when two units of delay are needed, then two delay components (e.g. 1010a and 1000b) are switched into the path by setting switch 1020b to position “A”. Switches 1020c through 1020n remains in position “B”. Thus, depending on the amount of delay to be introduced, additional delay components may be placed into the path of the red component signal in a similar manner. The total amount of delay applied is the sum of the delay introduced by each delay component placed into the signal path. The resulting delayed output signal of the adjustable delay circuit for input color component R_{X} 1001R is represented by output signal R_{Y} 1002R.

Thus, adjustments can be made as required to each color component signal when the skew is detected as being out of tolerance. In one or more embodiments, skew measurements and adjustments are made, once the reference signals are detected, gain compensation is made, and the reference pulse signals generated. Thus if cable 106 is changed or signals switched and the skew changes for any reason, the skew will be compensated for automatically.

In one or more embodiments, the video output amplifiers 640 and skew adjustment circuit 630 are continuously compensated for DC offset by DC offset compensation circuits 622.

Referring back to FIG. 6, each DC offset compensation circuit 622 comprises a feedback loop around skew adjustment circuit 630 and video output amplifiers 640. The DC offset compensation circuit 622 for each respective color component signal (i.e. 622B, 622G or 622R) measures the signal offset at the respective output amplifier 640 to generate a correction signal. The DC offset may be due to the structure of the delay components used for skew compensation, for example. The correction signal feeds back and sums with the respective gain compensated video signal (from the respective discrete amplifier 620) in respective summing node 624.

Output signals 602R, 602G and 602B (i.e. for RGBHV video format) are generated by stripping the sync signals (e.g. 603H and 603V) from the video signal components at respective output stages 640R, 640G and 640B. In one or more embodiments, an output stage 640 comprises a switch that grounds the video output during the sync period. When either the vertical sync (e.g. 603V) or the horizontal sync (e.g. 603H) pulse is present for any video component signal, the video output (i.e. 602) is switched to ground; otherwise, the video output is switched to the corresponding video signal output of skew adjustment circuit 630. An embodiment of a switch arrangement is illustrated in FIG. 7. In other non-RGBHV video formats the sync signals may not be stripped and/or sync signals added to re-constitute the video format being transmitted.

In FIG. 7, R_{X} 701 is the video source from the output of skew adjustment circuit 630, and R_{Y} 702 is the stripped video output. The vertical sync strip signal (i.e. V_{Sync}) is wired-OR with the horizontal sync strip signal (i.e. H_{Sync}) to generate the switch Select signal. When the Select signal is true (“T”) the video output, R_{Y} 702, is coupled to ground through switch 710 to remove the sync pulse. Otherwise, i.e. when the Select signal is false (“F”), the video output R_{Y} 702 is coupled to the input signal, R_{X} 701. In one or more embodiments, the vertical and horizontal sync strip signals are provided to output stages 640 via circuitry using input signals coupled to outputs of sync detectors 650H and 650V.

In the embodiment of FIG. 6, the sync pulses are detected by comparing the appropriate color component signal (e.g. the Red (i.e. R_{Y}) component for the vertical sync signal and the Blue (i.e. B_{Y}) component for the horizontal sync signal) at the corresponding output of skew adjustment circuit 630 against two reference voltage levels. A comparator may be used for such comparison. Thus, in the embodiment of FIG. 6, the vertical sync signal is generated by vertical sync detector 650V when the R_{Y} output of skew adjustment circuit 630 meets the reference voltage threshold level (V_{REF}), and the horizontal sync signal is generated by horizontal sync detector 650H when the B_{Y} output of skew adjustment circuit 630 meets the reference voltage threshold level (H_{REF}).

Thus, a novel skew compensation method and system for video transmitted over multiple conductor pairs has been described. It will be understood that the above described arrangements of apparatus and methods are merely illustrative of applications of the principles of this invention and many other embodiments and modifications may be made without departing from the spirit and scope of the invention as defined in the claims. For example, although example embodiments have been described for video signals that comprise three color components transmitted over three conductor pairs, the invention can be used with any type of multi-component signal that is transmitted over any number of conductors, as will be understood by those of skill in the art.

What is claimed is:

1. A method for automatic compensating of skew in a signal comprising a plurality of components transmitted over a plurality of conductors comprising:
providing a reference signal to said plurality of components;
transmitting said plurality of components over a plurality of conductors;
receiving said plurality of components transmitted over said plurality of conductors;
detecting said reference signals provided to said plurality of components;
determining skew between a first of said plurality components and a second one of said plurality of components; and
applying delay compensation to said second of said plurality components.

2. The method of claim 1, wherein said signal comprising a plurality of components comprises a video signal.

3. The method of claim 1, wherein said reference signal comprises a reference pulse signal.

4. The method of claim 1, wherein said plurality of conductors comprises a plurality of conductor pairs.

5. The method of claim 4 wherein said plurality of conductor pairs comprise a plurality of twisted conductor pairs.

6. The method of claim 5, wherein said plurality of conductor pairs comprise a CAT5 cable.

7. The method of claim 3, wherein said reference pulse signal comprises a video sync signal.

8. The method of claim 7 wherein said video sync signal comprises a horizontal sync signal.

9. A method for compensation of skew in video transmitted over twisted pair conductors comprising:
receiving a first video signal component over a first twisted pair of conductors, wherein said first video signal component includes a first reference pulse signal;
receiving a second video signal component over a second pair of twisted conductors, wherein said second video signal component includes a second reference pulse signal;
detecting said first reference pulse signal in said received first video signal component;
detecting said second reference pulse signal in said second received video signal component;
determining skew between said first reference pulse signal and said second reference pulse signal; and
applying delay compensation to a first arriving one of said first reference pulse signal and said second reference pulse signal to reduce the skew between said first reference pulse signal and said second reference pulse signal.

10. The method of claim 9, wherein said step of detecting of said first reference pulse signal comprises generating a first pulse signal when said first received video signal component traverses a reference voltage level.

11. The method of claim 9, wherein said step of determining skew comprises:
obtaining at least one sample of said first reference pulse signal;
obtaining at least one sample of said second reference pulse signal; and
computing said skew by determining a difference in time between said sample of said first reference pulse signal and said sample of said second reference pulse signal.

12. The method of claim 9, wherein said delay compensation is applied using at least one all-pass filter.

13. The method of claim 9, wherein said delay compensation is applied using at least one non-minimum phase filter.

14. The method of claim 9, wherein said first and second video signal components comprise components of an RGB video.

15. The method of claim 9, wherein said first and second video signal components comprise differential signals.

16. An apparatus for compensation of skew in video transmitted over twisted pair conductors comprising:
a circuit for receiving a plurality of video signals, each one of said plurality of video signals including a reference pulse signal;
a detector circuit for detecting said reference pulse signal in said plurality of video signals;
a skew determination circuit for determining skew between a first one of said plurality of video signals and a second one of said plurality of video signals; and
an adjustable delay circuit for applying an adjustable delay to said first and second of said plurality of video signals to reduce said skew.

17. The apparatus of claim 16, wherein said detector circuit comprises a high speed comparator.

18. The apparatus of claim 16, wherein said skew determination circuit comprises a skew capture circuit controlled by a micro-controller.

19. The apparatus of claim 16, wherein said adjustable delay circuit comprises at least one all-pass filter.

20. The apparatus of claim 16, wherein said adjustable delay circuit comprises at least one non-minimum phase filter.
